(19) United States
(12) Patent Application Publication
(10) Pub. No.: US 2004/0111856 A1
(43) Pub. Date: Jun. 17, 2004

(54) Method of manufacturing MEMS Fabry-Perot device

(76) Inventors: Sean Chang, Taoyuan (TW); Chii-How Chang, Taoyuan (TW)

Correspondence Address: LAW OFFICES OF DAVID PAI, 1001 FOURTH AVENUE, SUITE 3200, SEATTLE, WA, 98154, US

(21) Appl. No.: 10/426,141

(22) Filed: Apr. 28, 2003

(30) Foreign Application Priority Data
Dec. 11, 2002 (TW) 91135906

(51) Int. Cl. B23Q 17/00

(52) U.S. Cl. 29/407.05; 29/458

(57) ABSTRACT

A method of manufacturing a MEMS Fabry-Perot deivce includes the steps of providing two base materials, forming depositions on distinct specified areas of the base materials by thin film deposition processes, and combining the two base materials with the resultant depositions in between. While the depositions are being formed, a film thickness monitor is used to precisely control the thickness of the depositions so as to make it stand at a value same as a desired cavity length of the MEMS Fabry-Perot device.

### BACKGROUND OF THE INVENTION

(a) Field of the Invention

The invention relates to a method of manufacturing a micro-electro-mechanical system (MEMS) Fabry-Perot device, and more particularly, to a method of manufacturing a MEMS Fabry-Perot device capable of precisely positioning two parallel members in a Fabry-Perot device.

(b) Description of the Related Art

Fabry-Perot devices can provide wavelength discrimination and thus are often applied in optical elements such as tunable filters, wavelength lockers and tunable lasers. Referring to FIG. 1, a Fabry-Perot device 100 comprises two parallel members 102 and 104 with a plurality of spacing elements 106 having a thickness of d in between. Reflection layers are coated on one surface of the members 102 and 104 to form two parallel reflectors 102A and 104A opposite each other. When an incident light enters the device 100 at an angle α, a stationary standing-wave pattern is produced between the parallel reflectors 102A and 104A as the cavity is an integral number of half wavelengths long. Thereby, light beams at specific wavelengths within a range that are resonant are output as shown in FIG. 2.

In order to minimize the size of the Fabry-Perot devices, micro-electro-mechanical systems (MEMS) manufacturing processes have been applied for fabricating the same devices during recent years. However, the complexity of fabricating and assembling the members of a MEMS Fabry-Perot device rises accordingly, for that the reflectors 102A and 104A need to maintain an exceptionally high parallelism (the angle tolerance being less than 10⁻⁵ degree) and the interval d between the parallel reflectors should possess precise accuracy (the tolerance being less than 0.5 nm) to form a Fabry-Perot resonance cavity. In addition, the interval d is generally a minute measurement from one to tens of μm, thus making it relatively difficult to fabricate spacing elements having a same thickness. On top of that, it is also essential that the optical mirror flatness of reflectors 102A and 104A maintains the value of λ/50 P-V.

FIGS. 3A to 3D show sectional schematic views illustrating the manufacturing process of a prior MEMS Fabry-Perot device.

Referring to FIG. 3A, according to the prior method, a photoresist 204 is first applied onto a base material 202 made of silicon wafer or glass substrate, appropriate exposure of the base material 202 after covering with a photomask 206 is performed, and then the exposed photoresist is removed using developer to form the structure as shown in FIG. 3B. Next, the remaining photoresist 204 is eliminated after obtaining a desired thickness d by etching the base material 202 as shown in FIG. 3C. The procedure is followed by placing another base material 208 also made of silicon wafer or glass substrate on top of the base material 202 and the two base materials are combined under high temperatures and pressures or by anodic bonding method to finally form a MEMS Fabry-Perot device 200 having a cavity length d as shown in FIG. 3D.

Nevertheless, by the aforesaid method of etching the base material 202 for manufacturing the Fabry-Perot device with the cavity length d, it is improbable to maintain the etching depth accuracy within 0.5 nm. Also, etching may easily damage the surface of the base material 202, and the optical mirror flatness of the etched surface may consequently fail to maintain a value of λ/50 P-V.

FIGS. 4A to 4E are sectional schematic views of a manufacturing procedure illustrating another manufacturing method of the prior Fabry-Perot device. Referring to FIG. 4A, an adhesive layer 310 such as thermosetting adhesive having a thickness d interposes between a base material 302 and a photoresist 304. Exposure and development processes for the photoresist 304 are carried out by employing a photomask 306 similarly as in the aforesaid method, and then the adhesive layer 310 is etched as shown in FIGS. 4B and 4C. After eliminating the remaining photoresist 304, as indicated by FIG. 4D, a spacing element 310 having a thickness d is formed by the remaining adhesive layer solidifying under high temperature. Another base material 308 is combined on top of the spacing element 310, thus forming a MEMS Fabry-Perot device 300 having a cavity length d as shown in FIG. 4E.

However, although this method does not cause damage on the surface flatness of the base material 302 because the etching liquid targets at the adhesive layer 310 rather than the base material 302, it is unlikely to maintain the etching depth accuracy of the adhesive layer 310 within 0.5 nm. Furthermore, during the combination of the base material 308 and the base material 302, the thickness of the adhesive layer is liable to change because the adhesive layer is less hard compared to silicon wafer or glass substrate.

As a result, the prior MEMS manufacturing methods for making Fabry-Perot devices fail to meet the accuracy requirement of the manufacturing parameters, thus they are incapable of manufacturing MEMS Fabry-Perot devices that precisely transmit optical waves conforming to a desired output.

### SUMMARY OF THE INVENTION

An object of the invention is to provide a method of manufacturing a MEMS Fabry-Perot device capable of precisely positioning the two parallel members in the Fabry-Perot device.

According to an embodiment of the invention, a dielectric material is deposited on the surface of a base material using thin film deposition processes to form a plurality of spacing elements on distinct coating areas specified by a photomask or a photoresist, and another base material is combined by means of an adhesive. The base materials are made of silicon wafer or glass substrate coated with a reflection layer. During the deposition on the surface of the base material, a film thickness monitor is used to precisely monitor the film thickness within an accuracy of 0.1 nm or less, and it is ensured that the interval between the two parallel members of the MEMS Fabry-Perot device equals the desired cavity length.

In connection with the invention, by thin film deposition processes used for making spacing elements and a film thickness monitor for monitoring the thickness of the spacing elements, various crucial manufacturing parameters that affect output waveforms can be accurately controlled and the surface flatness of the parallel members can also be ensured. Consequently, a MEMS Fabry-Perot device capable of accurately outputting the desired waveforms is made.

### BRIEF DESCRIPTION OF THE DRAWINGS

FIG. 1 shows a schematic view of a Fabry-Perot cavity.

FIG. 2 shows an output waveform of light after passing through a Fabry-Perot device.

FIGS. 3A to 3D show sectional schematic views illustrating the manufacturing procedure of a prior method of manufacturing a MEMS Fabry-Perot device.

FIGS. 4A to 4E show sectional schematic views illustrating the manufacturing procedure of another prior method of manufacturing a MEMS Fabry-Perot device.

FIGS. 5A to 5C show sectional schematic views illustrating the manufacturing method of a MEMS Fabry-Perot device of an embodiment in accordance with the invention.

FIG. 6A is a top view showing the configuration of the spacing elements of a MEMS Fabry-Perot device manufactured by the method in accordance with the invention.

FIG. 6B is a top view showing an adapted configuration of the spacing elements of a MEMS Fabry-Perot device manufactured by the method in accordance with the invention.

FIG. 7 shows a sectional schematic view of a supporting member applied in coordination with a planar photomask.

FIG. 8 shows a sectional schematic view illustrating a photoresist being used as a spacer during thin film deposition processes.

FIGS. 9A and 9B show sectional schematic views illustrating the manufacturing method of a MEMS Fabry-Perot device of another embodiment in accordance with the invention.

### DETAILED DESCRIPTION OF THE PREFERRED EMBODIMENTS

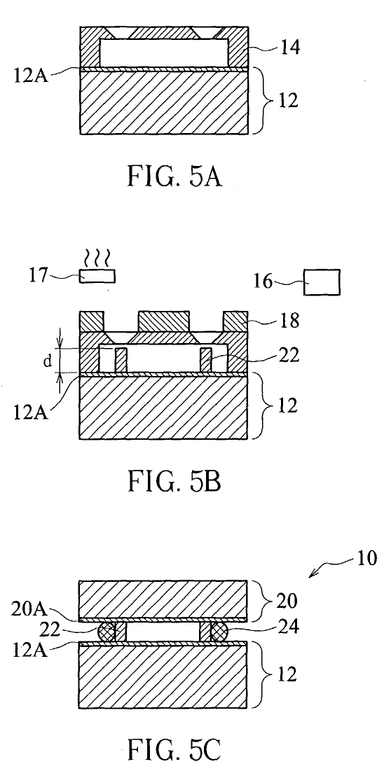

FIGS. 5A to 5C show sectional views of the manufacturing procedure illustrating the method of manufacturing a MEMS Fabry-Perot device of an embodiment in accordance with the invention.

Referring to FIG. 5A, a base material 12 made of silicon wafer or glass substrate with a reflection layer 12A is first provided. Then a photomask 14 for specifying the coating area required by the subsequent steps is covered on top of the base material 12.

Referring to FIG. 5B, using physical vapor deposition (PVD) or chemical vapor deposition (CVD) processes, a deposition material 18 such as a dielectric material or metal (silver or aluminum for instance) from a coating material source 17 is deposited onto distinct areas of the surface of the base material 12 specified by the photomask 14, so as to form a plurality of spacing elements 22 on distinct specified areas. The dielectric materials may be any deposition material that can be applied by thin film deposition processes using PVD or CVD, for example, SiO₂ and TiO₂.

While depositions are being formed on the surface of the base material 12, the invention employs a film thickness monitor 16 to monitor the thickness of the coating film. The film thickness monitor 16 may be a quartz crystal oscillator film thickness monitor or an optical film thickness monitor capable of precisely monitoring the film thickness within the accuracy of 0.1 nm or less. Through the film thickness monitor 16, the thickness of the spacing elements is precisely controlled such that the deposition is ceased once the thickness of the coating film reaches the desired cavity length d of a Fabry-Perot device. Next, referring to FIG. 5C, the photomask 14 is removed and another base material 20, similarly made of silicon wafer or glass substrate coated with a reflection layer 20A, is adhered to the top of the spacing elements on the base material 12. Finally, the base material 20 and the base material 12 are combined using physical methods such as adhering by means of an adhesive 24, which is applied either between the two different base materials or between the spacing elements and the base materials, thus forming the MEMS Fabry-Perot device 10 having parallel members with a cavity length d in between as shown in FIG. 5C.

The advantages of the invention will be described and illustrated in the following.

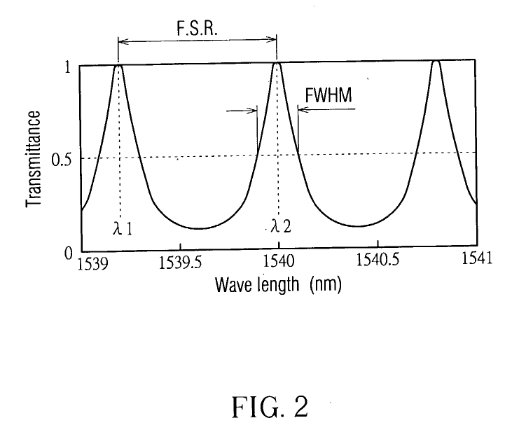

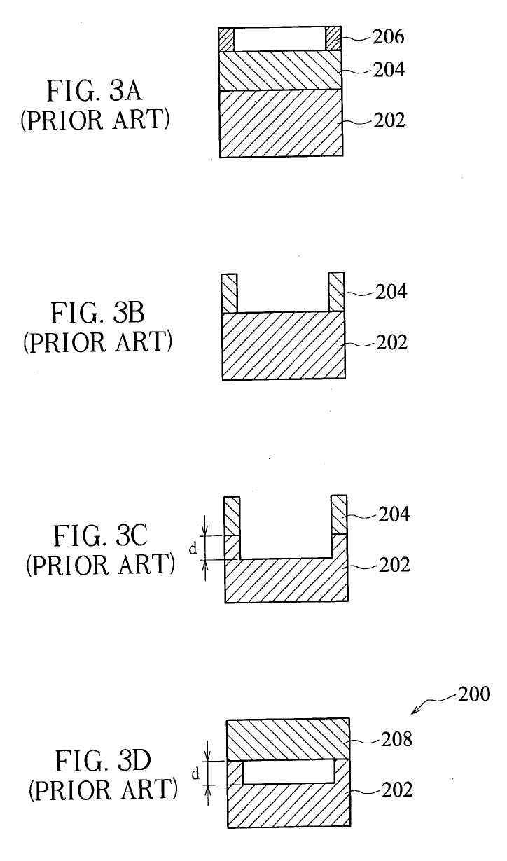

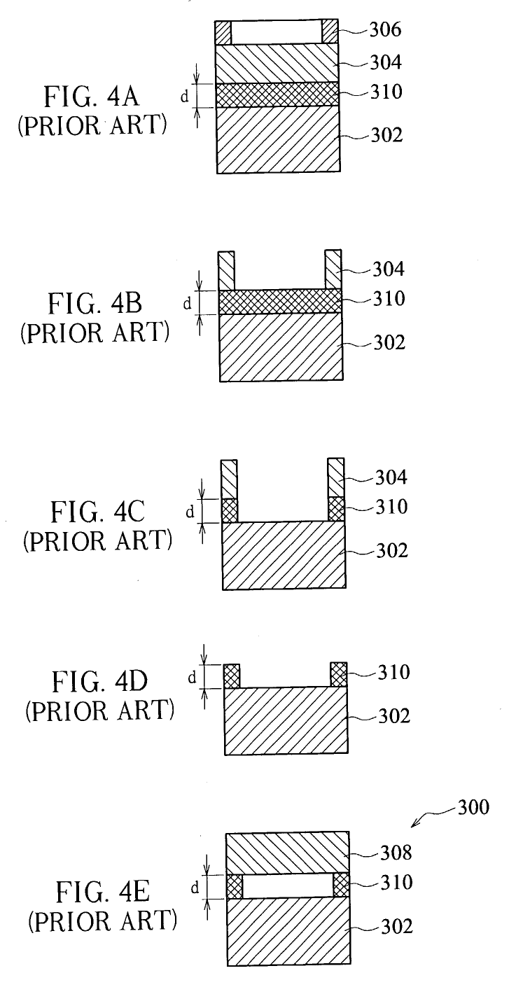

Referring to FIG. 2, the output waveforms of the Fabry-Perot device are defined by the parameters below:

1. Free Spectral Range (FSR):

FSR=λ²/(2ndcos(θ))

wherein λ is the wavelength of incident light, n is the index of refraction, d is the cavity length between the two parallel members in the Fabry-Perot device, and θ is the angle of incidence;

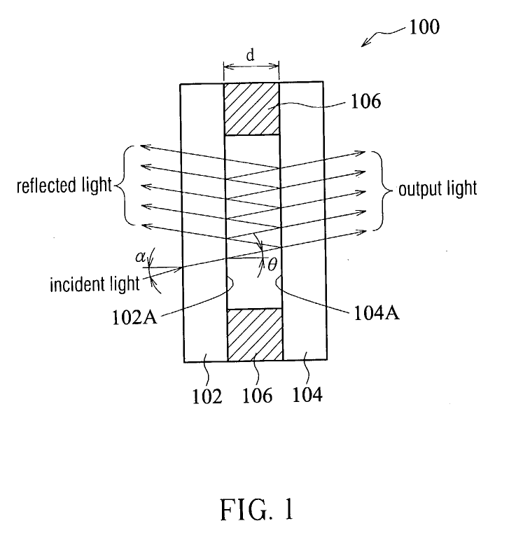

2. Finesse (F):

$$\begin{matrix}\frac{1}{{F}^{2}} = \frac{1}{{F}_{R}^{2}} + \frac{1}{{F}_{T}^{2}} + \frac{1}{{F}_{P}^{2}} \\ {F}_{R} = \frac{{π ( {R}_{1} {R}_{2} )}^{\frac{1}{4}}}{1 - \sqrt{{R}_{1} {R}_{2}}} \\ {F}_{T} = \frac{λ}{2 D δ}\end{matrix}$$

wherein Fₚ is the surface finesse of the parallel reflectors 102A and 104A, R₁ and R₂ are the refractive indexes of the reflectors 102A and 104A in FIG. 1, respectively, D is the aperture diameter of the Fabry-Perot device for allowing light to pass through, and δ is the included angle of the two parallel members;

3. Full Width at Half Maximum (FWHM):

FWHM=FSR/F

It is observed that, the cavity length d and the included angle δ of the two parallel members both affect the FWHM and are key factors for changing the output waveforms of the Fabry-Perot device. Therefore, in connection with the invention, spacing elements 22 are made using thin film deposition processes and a film thickness monitor 16 is employed for precisely monitoring the thickness of the spacing elements 22. Since the film thickness monitor 16 can precisely monitor the film thickness within an accuracy of 0.1 nm or less, it is ensured that the cavity length between the two parallel members of the MEMS Fabry-Perot device equals the desired cavity length d, and thereby acquiring accurate values of FSR and FWHM. In addition, since the film thickness monitor 16 monitors the thickness of each spacing elements 22 formed on a same surface within an accuracy of 0.1 nm or less, the parallelism between the two elements can be easily and precisely maintained (i.e., the included angle of the two elements is zero).

Furthermore, since the spacing elements 22 are formed by thin film deposition processes and etching the silicon wafer or glass substrate is avoided, the Fabry-Perot device according to the invention can provide a better optical mirror flatness. Also, the cavity length d is improbable to change because the spacing elements 22 are hard enough to prevent deformation.

Therefore, in connection with the invention, by thin film deposition processes used for making spacing elements 22 and a film thickness monitor 16 for monitoring the thickness of the spacing elements, various crucial manufacturing parameters that affect output waveforms can be accurately controlled and the surface flatness of the parallel members can also be ensured. Thereby, a MEMS Fabry-Perot device capable of accurately outputting the desired waveforms is made.

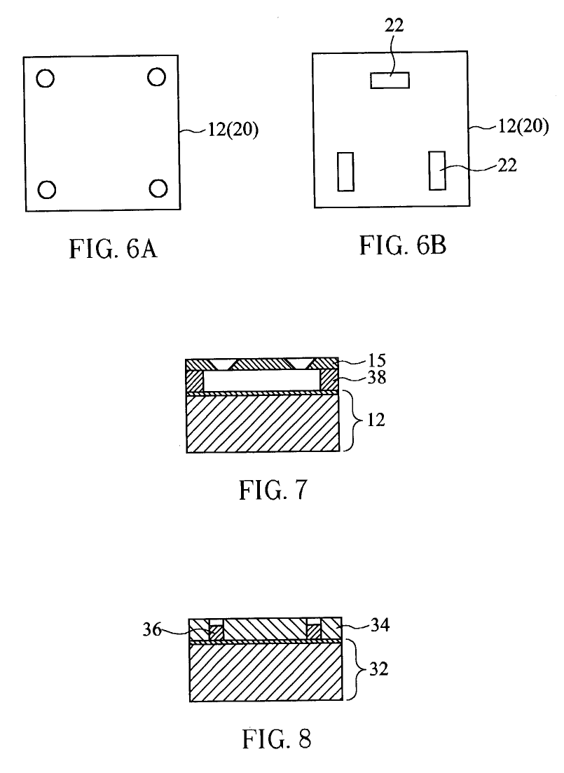

FIG. 6A is a top view showing the configuration of the spacing elements 22 of the MEMS Fabry-Perot device 10 in accordance with the invention. It is seen that, viewing from the top, four circular spacing elements 22 are distributed around the base material. However, the shape and number of the spacing elements 22 are not limited, for example, viewing from the top, they may also be rectangular spacing elements displaying a triangular distribution around the base material as shown in FIG. 6B. Nevertheless, the number of the spacing elements 22 is preferably three or more because three or more spacing elements may form a coplanar relationship among them for further ensuring the parallelism between the two elements in the Fabry-Perot device.

In addition, with regard to the photomask for specifying the coating areas, only a space enclosed by the photomask having a height larger than the desired cavity length d needs to be provided and the photomask may be in any shape as well. For instance, referring to FIG. 7, supporting members 38 each having the same thickness may be used to lift a photomask 15 with a planar shape and enough space for the desired cavity length d is produced.

FIG. 8 shows a method in which photoresist 34 rather than the photomask 14 is employed as a spacer for specifying the coating areas during the thin film deposition processes. Referring to FIG. 8, the photoresist 34 may be applied on the base material 32 and occupies the surface areas except for the specified coating area. The photoresist 34 is then removed when spacing elements 36 having a thickness d are formed.

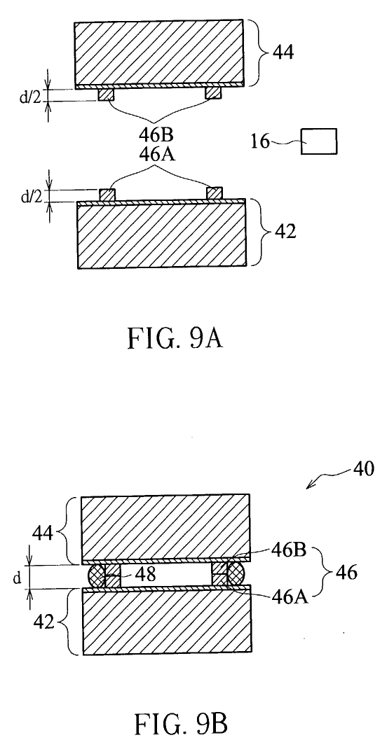

FIGS. 9A and 9B are sectional views illustrating the manufacturing method of another embodiment in accordance with the invention. Referring to FIG. 9A, a plurality of spacing elements 46A and 46B having a predetermined thickness are formed onto two different base materials 42 and 44 by deposition, and the method of forming the spacing elements 46A and 46B are the same as that of the aforesaid embodiment. Each of the spacing elements 46A and 46B has a predetermined thickness that is half the desired cavity length d, and the base materials 42 and 44 are combined through the corresponding deposited elements 46A and 46B by means of an adhesive 48, thus forming a MEMS Fabry-Perot device 40 having a desired cavity length d.

It is understood from the above embodiment that, by the method in connection with the invention, the respective deposition thickness of the corresponding deposited elements 46A and 46B formed on the different base materials may be varied as required as long as the condition is satisfied that the total thickness of the spacing elements 46A and 46B is equal to the desired cavity length d.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of manufacturing a micro-electro-mechanical system (MEMS) Fabry-Perot device, comprising the steps of:
providing two base materials;
forming depositions onto predetermined areas on the surface of the base materials;
monitoring the thickness of the depositions using a film thickness monitor; and
combining the two base materials with the depositions in between; wherein the thickness of the resultant depositions is equal to a desired cavity length of the MEMS Fabry-Perot device.

2. The method of manufacturing a MEMS Fabry-Perot device as described in claim 1 further comprising a step of specifying the predetermined areas using a spacer.

3. The method of manufacturing a MEMS Fabry-Perot device as described in claim 2, wherein the spacer is a photomask.

4. The method of manufacturing a MEMS Fabry-Perot device as described in claim 2, wherein the spacer is a photoresist.

5. The method of manufacturing a MEMS Fabry-Perot device as described in claim 1, wherein the base material is made of a silicon wafer coated with a reflection layer.

6. The method of manufacturing a MEMS Fabry-Perot device as described in claim 1, wherein the base material is made of a glass substrate coated with a reflection layer.

7. The method of manufacturing a MEMS Fabry-Perot device as described in claim 1, wherein the film thickness monitor is a quartz crystal oscillator film thickness monitor.

8. The method of manufacturing a MEMS Fabry-Perot device as described in claim 1, wherein the film thickness monitor is an optical film thickness monitor.

9. The method of manufacturing a MEMS Fabry-Perot device as described in claim 1, wherein physical vapor deposition (PVD) processes are adopted for depositing a dielectric material onto the predetermined areas.

10. The method of manufacturing a MEMS Fabry-Perot device as described in claim 1, wherein chemical vapor deposition (CVD) processes are adopted for depositing a dielectric material onto the predetermined areas.

11. The method of manufacturing a MEMS Fabry-Perot device as described in claim 1, wherein physical vapor deposition (PVD) processes are adopted for depositing a metal material onto the predetermined areas.

12. The method of manufacturing a MEMS Fabry-Perot device as described in claim 1, wherein chemical vapor deposition (CVD) processes are adopted for depositing a metal material onto the predetermined areas.

13. The method of manufacturing a MEMS Fabry-Perot device as described in claim 1, wherein the two base materials are combined to have the depositions in between by adhering.

14. A method of manufacturing a MEMS Fabry-Perot device, comprising the steps of:
providing a first base material;
forming depositions onto a plurality of predetermined areas on the surface of the first base material;
monitoring the thickness of the depositions using a film thickness monitor; and
providing a second base material for combining with the first base material having the depositions in between;
wherein the thickness of the depositions between the base materials is equal to a desired cavity length of the MEMS Fabry-Perot device.

15. The method of manufacturing a MEMS Fabry-Perot device as described in claim 14 further comprising a step of specifying the predetermined areas using a spacer.

16. The method of manufacturing a MEMS Fabry-Perot device as described in claim 15, wherein the spacer is a photomask or a photoresist.

17. The method of manufacturing a MEMS Fabry-Perot device as described in claim 14, wherein PVD or CVD processes are adopted for forming the depositions.

18. The method of manufacturing a MEMS Fabry-Perot device as described in claim 14, wherein the base material is made of a silicon wafer or glass substrate coated with a reflection layer.

19. A method of manufacturing a MEMS Fabry-Perot device, comprising the steps of:
forming a first deposition onto predetermined areas of a first base material;
forming a second deposition onto a second base material at areas corresponding to the predetermined areas of the first base material;
monitoring the thickness of the first and second depositions using a film thickness monitor; and
combining the first and second base materials with the first and second depositions connected in between;
wherein the combined thickness of the first and second depositions is equal to a desired cavity length of the MEMS Fabry-Perot device.

20. The method of manufacturing a MEMS Fabry-Perot device as described in claim 19 further comprising a step of specifying the predetermined areas using a spacer.

21. The method of manufacturing a MEMS Fabry-Perot device as described in claim 20, wherein the spacer is a photomask or a photoresist.

22. The method of manufacturing a MEMS Fabry-Perot device as described in claim 19, wherein PVD or CVD processes are adopted for forming the depositions.

23. The method of manufacturing a MEMS Fabry-Perot device as described in claim 19, wherein the base material is made of a silicon wafer or glass substrate coated with a reflection layer.
